(19) United States
(12) Patent Application Publication
(10) Pub. No.: US 2018/0213821 A1
(43) Pub. Date: Aug. 2, 2018

(54) METHOD FOR SELECTING PETFOODS HAVING A PALATABILITY EFFECT AND A CALORIE INTAKE REDUCING EFFECT FOR PETS

(71) Applicant: SPECIALITES PET FOOD, Elven (FR)

(72) Inventors: Julien ROGUES, Lannion (FR); Cécile NICERON, Bayonne (FR)

(73) Assignee: SPECIALITES PET FOOD, Elven (FR)

(21) Appl. No.: 15/302,610

(22) PCT Filed: Apr. 7, 2015
(86) PCT No.: PCT/EP2015/057498

§ 371 Date: Apr. 13, 2018

(30) Foreign Application Priority Data
Apr. 8, 2014 (EP) 14305513.5

(51) Int. Cl. A23K 50/42; A23K 20/10

(52) U.S. Cl. CPC A23K 50/42; A23K 20/10

(57) ABSTRACT

The present invention provides a method for selecting a petfood having both a palatability effect and a calorie intake reducing effect for pets, said method being based on a specific analysis of data collected in a pet feeding trial. The present invention further provides an automated pet feeding system for use in a pet feeding trial according to such a method, as well as a method for feeding a pet with a petfood having both a palatability effect and a calorie intake reducing effect for pets.

The present invention relates to the general technical field of methods for analyzing pet behavioral responses to petfoods.

More specifically, the present invention provides a method for selecting a petfood having both a palatability effect and a calorie intake reducing effect for pets, said method being based on a specific analysis of data collected in a pet feeding trial.

The present invention further provides an automated pet feeding system for use in a pet feeding trial according to such a method, as well as a method for preparing a petfood having both a palatability effect and a calorie intake reducing effect for pets.

### BACKGROUND OF THE INVENTION

Various methods and devices for automated pet management are known. Such methods and devices generally differ depending on the field (e.g., livestock industry or petfood industry) and the aim(s) to achieve (e.g., management of herds in terms of health and nutrition, or provision of successful petfood commercial ranges, respectively).

In the particular field of petfood industry, it is common to test pet acceptance and response to a petfood prior to its launch in the marketplace. Accordingly, animals are usually subjected to petfood testing methods in which they are required to have access to one or more petfoods. Such methods conventionally involve quantitative measurement of petfood consumption as well as visual images of the pet behavorial response to a petfood, leading thus to information about petfood properties and/or pet behavior.

Means are therefore required to provide accurate and valid petfood testing methods. It is important that these methods not only are capable of controlling food access to the animals in a safe and reliable way, but also are appropriately designed to enable to collect the required data and to manage these data so as to determine (qualitatively and/or quantitatively) one or more specific functional properties of interest of the tested petfood.

In this respect, one of such specific functional properties of interest of a petfood to be tested is palatability. Palatability is the measure of intake of a food that indicates acceptance or the measure of preference of one food over another. Petfood palatability is commonly measured using a single-bowl or a two-bowl assay. Using a single-bowl or monadic test, one can measure acceptance for answering to the question: “does the animal accept/refuse the food?” Using a two-bowl or versus test, one can measure preference for answering to the question: “which food does the animal prefer?” This latter test is logically of great interest for the petfood industry aiming at developing markedly improved new products over existing ones. All these tests can be performed either on trained animal panels under a controlled environment such as in a laboratory or a research facility, or in-home which is the actual environment where the petfood will be consumed.

For instance, International patent application WO 2009/056260 discloses a remote data collecting system for testing palatability of petfoods by determining intake date for at least two different petfoods that are provided in at least two scales of a measuring device.

But palatability, although essential, is not the only one functional property of interest of a petfood.

In particular, pet weight management is a so growing concern that the petfood industry is interested in developing satiating and/or hypocaloric petfoods. Of course, such petfoods will have a commercial interest only if they are also palatable, otherwise they will not be even eaten by the animals.

Using standard palatability tests such as versus tests, one typically concludes that the higher the food intake, the higher the food palatability. This is illustrated by the following theoretical example:

Petfood A is palatable.

Petfood B is as palatable as petfood A, and it is satiating.

Petfood C is as palatable as petfood A, and it is hypocaloric.

Testing petfoods A, B and C in versus will give the results set forth in Table 1 below, based on a comparison of consumed food amounts (expressed in g or as consumption ratios):

TABLE 1

| | Petfood A | Petfood B |
|---|---|---|
| At the end of | ++ | + |
| the test | | |

As shown in Table 1, determining the consumption ratio will lead to the conclusion that petfood A is more palatable than petfood B, which is not true.

TABLE 2

| | Petfood A | Petfood C |
|---|---|---|
| At the end of | ++ | ++ |
| the test | | |

As shown in Table 2, determining the consumption ratio will lead to the sole conclusion that petfoods A and C have a similar palatability level. Indeed, it will not be possible to detect the hypocaloric property of petfood C.

Indeed, taking a satiating petfood as an example, the main difficulty is to be able to ensure that a lack or a reduction of consumption of the food is not due to a lack of palatability but to an actual satiating effect. In addition, if a petfood is both palatable and satiating, this obviously leads to a misinterpretation of the consumption data that are made available using versus tests.

This shows that testing a satiating petfood in versus will most of the time lead to a biased conclusion since the reduced consumption globally observed due to the satiating effect of a food is masked by the palatability assessment wherein a palatable food leads to an increased consumption.

Actually, a satiating food is associated with a consumption decrease over time. And more than a consistent consumption decrease, monitoring the consumption of a satiating food enables one to observe a consumption drop (either a regular decrease or a sudden decrease).

Besides, as shown in Table 2 above, testing two petfoods in versus does not make it possible to determine a hypocaloric effect of one of the two foods since, as soon as they have a similar palatability level, both will be consumed in similar amounts (expressed in grams or as consumption ratios), even if one is hypocaloric while the other is not.

Thus, there is a clear need in the art for a relevant method enabling one to accurately measure the satiating and/or hypocaloric effect of a palatable petfood.

### SUMMARY OF THE INVENTION

Advantageously considering that feeding a pet with a satiating and/or hypocaloric petfood results in a reduction of the total calorie intake, the present invention addresses the foregoing need in the art by providing a method for assessing functional properties of candidate petfoods through a pet feeding trial enabling relevant data collection and intensive pet behavior analysis, to get a result having a high level of significance and accuracy, said method making it possible for the first time to select a petfood the functional properties of which combine palatability and reduction of calories supply.

In the present context, only a monadic feeding trial is of relevance. And as shown herein, the essential criteria to be determined for one pet, for appropriately discriminating between a petfood that is both palatable and calorie intake reducing and a petfood that is not palatable, although being potentially calorie intake reducing, are:
The total of consumed calories by the pet throughout the feeding trial (tC); and
at least one from:
   The latency time or time before the first feeding event (DFE1), which is the time between the start of the feeding trial and the pet's first feeding event: the pet should not take too long to taste the food otherwise the pet's owner perceives the food as not palatable; and
   The number of feeding events with low or no food intake during the feeding trial (NbFElow): these feeding events are typically strongly correlated to a low palatability of the petfood.

An object of the present invention concerns a method for selecting a petfood having both a palatability effect and a calorie intake reducing effect for pets.

A further object of the present invention relates to an automated pet feeding system for use in a pet feeding trial according to the foregoing method.

Yet a further object of the present invention is related to a method for preparing a petfood having both a palatability effect and a calorie intake reducing effect for pets.

### BRIEF DESCRIPTION OF THE FIGURES

FIG. 1. Schematic representation of a method for selecting a petfood having both a palatability effect and a calorie intake reducing effect for pets, according to the present invention.

FIG. 2. Schematic representation of the kinetics of consumption for 4 products being palatable and having or not a calorie intake reducing effect.

FIG. 3. Illustration of the kinetics of consumption of Control petfood A and Experimental petfood 1.

FIG. 4. Illustration of the kinetics of consumption of Control petfood A and Experimental petfood 2.

### DETAILED DESCRIPTION OF THE INVENTION

### Definitions

In the present disclosure, ranges are stated in shorthand, so as to avoid having to set out at length and describe each and every value within the range. Any appropriate value within the range can be selected, where appropriate, as the upper value, lower value, or the terminus of the range. For example, a range of 0.1-1.0 represents the terminal values of 0.1 and 1.0, as well as the intermediate values of 0.2, 0.3, 0.4, 0.5, 0.6, 0.7, 0.8, 0.9, and all intermediate ranges encompassed within 0.1-1.0, such as 0.2-0.5, 0.2-0.8, 0.7-1.0, etc.

As used throughout, the singular form of a word includes the plural, and vice versa, unless the context clearly dictates otherwise. Thus, the references “a”, “an”, and “the” are generally inclusive of the plurals of the respective terms. For example, reference to “a method” or “a petfood” includes a plurality of such “methods” or “petfoods”. Similarly, the words “comprise”, “comprises”, and “comprising” are to be interpreted inclusively. Likewise the terms “include”, “including” and “or” should all be construed to be inclusive. All these terms however have to be considered as encompassing exclusive embodiments that may also be referred to using words such as “consist of”.

The methods and products and other embodiments exemplified here are not limited to the particular methodologies and protocols that are described herein because, as the skilled artisan will appreciate, they may vary.

Unless defined otherwise, all technical and scientific terms, terms of art, and acronyms used herein have the meanings commonly understood by the skilled artisan in the field(s) of the invention, or in the field(s) where the term is used. Although any products, methods, or other means or materials similar or equivalent to those described herein can be used in the practice of the present invention, the preferred products, methods, or other means or materials are described herein.

The term “about” as used herein when referring to a measurable value such as an amount, a duration, and the like, is meant to encompass variations of ±15%, more preferably ±10%, even more preferably ±5% from the specified value, as such variations are appropriate to reproduce the disclosed methods and products.

In the context of the present invention, differences (“Δ”) are calculated and are considered only when statistically significant. It follows that, as used herein, the symbols “>” and “<” mean “significantly greater than” and “significantly less than”, respectively. As used herein, the symbols “≥” and “≤” mean “significantly greater than or non-significantly different” and “significantly less than or non-significantly different”, respectively. As used herein, the symbol “=” means “non-significantly different”. In all cases, the term “significantly” means “with a statistical significance”.

As used herein, the term “palatability” or “palatability effect” refers to the overall willingness of a pet to eat a certain petfood. Whenever a pet shows a preference, for example, for one of two or more petfoods, the preferred petfood is more “palatable”, and has “enhanced palatability”. Such preference can arise from any of the pet's senses, but typically is related to, inter alia, taste, aroma, flavour, texture, smell and/or mouth feel.

Different methods exist to determine a palatability effect. Examples of such methods involve exposure of pets to petfoods either simultaneously (for example, in side-by-side, free-choice comparisons, e.g., by measuring relative consumption of at least two different petfoods), or sequentially (e.g., using single bowl testing methodologies). Advantageously, at least two different methods may be used to consolidate the thus obtained results on the palatability effect of a given petfood.

In the present context, the palatability effect of a petfood is determined by a kinetic approach taking into account the quantities of the petfood that are consumed advantageously associated with temporal data related to these quantities.

By the term “calorie intake reducing effect” or “calorie intake reduction”, it is meant herein a decrease of calorie intake by pets of their own free will, thus preventing obesity, and/or controlling weight gain, and/or promoting satiety and/or promoting health of animals.

By the term “satiating effect”, it is meant herein the extinguishment of the sensation of hunger, which is often described as “feeling full”. The satiety response refers to behavioral characteristics observed to be consistent with having consumed a sufficient amount of food, such as an abrupt or a tapered down cessation of eating.

As used herein, “hypocaloric” petfoods are petfoods having a lower caloric density compared to a control petfood. It can be obtained by different ways, such as for example by decreasing fat content or by replacing digestible carbohydrates by less digestible carbohydrates (such as fibers). Preferably, the caloric density of a “hypocaloric” petfood may be from about 3 to about 35%, preferably from about 5 to about 20%, lower than that of a control petfood.

The present invention is dedicated to any class of “pets” or “companion animals”, such as cats, dogs, rabbits, guinea pigs, ferrets, hamsters, mice, gerbils, birds, horses, cows, goats, sheep, donkeys, pigs, and the like. Preferably, the pets under consideration in the context of the present invention are cats and dogs, yet preferably cats. If desired, the invention can be tested to evaluate its suitability for use with different classes of animals that may be considered as companion animals.

As used herein, the term “petfood” or “food” means a product or composition that is a “nutritionally-complete”, “nutritionally-balanced” or “complete and nutritionally-balanced food”.

A “nutritionally-complete”, “nutritionally-balanced”, or “complete and nutritionally-balanced food” is one that contains all known required nutrients for the intended recipient or consumer of the petfood, in appropriate amounts and proportions based, for example, on recommendations of recognized or competent authorities in the field of pet nutrition. Such petfoods are therefore capable of serving as a sole source of dietary intake to maintain life, without the addition of supplemental nutritional sources.

In the present context, a “candidate petfood” or “experimental petfood” is a petfood to be tested in the method of selection according to the present invention, whereas a “control petfood” is a petfood of reference. Thus, a “control petfood” is a petfood having a reference level of both palatability effect and calorie intake by the pet. To investigate the palatability effect and the calorie intake reducing effect of a “candidate petfood”, it is compared to a “control petfood” during a feeding trial.

There are three main categories or classes of petfoods depending on their moisture content, which is either low or medium or high:
dry or low moisture-containing products (having less than about 14% moisture): they usually produce a crunching sound when chewed by pets; they are generally highly nutritious, may be in expensively packaged (e.g., in bags or boxes), and are highly convenient to store and use; they are relatively shelf-stable and resistant to microbial or fungal deterioration or contamination;
canned or wet or high moisture-containing products (having more than about 50% moisture): typically high meat-containing products, they are usually costly to produce and package (mainly in cans); they are not shelf-stable when opened so that excess or unused wet food must be refrigerated to prevent microbial or fungal spoilage;
semi-moist or semi-dry or soft dry or soft moist or intermediate or medium moisture-containing products (having from about 14 to about 50% moisture): they are usually packaged in appropriate bags or boxes; they contain stabilizing agents and can thus be stored in the same way as dry products.

The term “kibble” used herein refers to particulate chunks or pieces formed by either a pelleting or extrusion process. Typically, kibbles are produced to give dry and semi-moist pet food. The pieces can vary in sizes and shapes, depending on the process or the equipment. For instance, kibbles can have spherical, cylindrical, oval, or similar shapes. They can have a largest dimension of less than about 2 cm for example.

The terms “chunk in jelly”, “chunk in gravy”, “loaf” as used herein refer to wet edible foodstuffs.

Conventional pet feeding trials to test petfoods are well known in the art. Examples of such trials include “monadic tests” and “versus tests”.

In a “monadic test” or “monadic feeding trial” or “single-bowl test”, only one food is given to pets at one given time, giving thus access to the appreciation of this specific petfood by the pet. When several petfoods are presented sequentially using monadic testing, the preference for one petfood compared to the other can be established by comparing the sequentially-collected data. In the present invention, the appreciation of the petfood is determined using several criteria, based on quantities of petfood consumed and temporal data associated with these quantities.

A “two-bowl test” or “two-pan test” or “versus test” enables one to determine preference of pets for one petfood compared simultaneously to another. A “versus test” is based on the postulate whereby the more food consumed, the more palatable it is.

As used herein, the term “petfood data” refers to any relevant information related to a petfood that enables one to appropriately characterize the petfood in the context of the present invention. Typically, the term “petfood data” refers to structural and/or commercial information such as the petfood identification, the analytical composition thereof, the list of ingredients contained therein, as well as any other type of information that can be found on a petfood bag or can.

The term “petfood identification” means herein any information enabling one to fully and unambiguously identify a petfood such as designation, name, brand, commercial reference, producer, and the like.

The term “petfood caloric density” as used herein means the amount of calories to be offered by a given amount or volume of a petfood. It can be expressed in different units such as calories (“cal”) or kilocalories (“Kcal”) or Joules (“J”) or KiloJoules (“KJ”) by gram or kilogram of petfood. It is commonly expressed in Kcal per Kg of food.

It is known to the one of ordinary skill in the art that the petfood caloric density includes metabolizable energy (ME).

By the term “metabolic energy (ME)” or “metabolizable energy (ME)” of a petfood, it is meant herein the energy available to a pet upon consumption of the petfood after subtracting the energy excreted in feces, urine, and combustible gases. “Metabolic energy” values may be determined by methods known by those skilled in the art, such as detailed in the Official Publication of The Association of American Feed Control Officials, Inc. or the National Research Council's Nutrient Requirements of Dogs and Cats, The National Academy Press, Washington, D.C., 2006. “Metabolic energy (ME)” can be expressed as kcal ME or KJoules ME per kg of petfood (dry matter).

As used herein, the term “feeding event”’ (FE) is when a pet is present at a feeding device as indicated by an access detector. It should be noted that a pet does not necessarily consume a petfood in a feeding event. A pet may engage in multiple feeding events in a given time period.

As used herein, the term “feeding event data” refers to any relevant information related to a feeding event that enables one to appropriately characterize this feeding event among all the feeding events occurring during a feeding trial. Typically, “feeding event data” encompass one or more of the following data: feeding event serial number, feeding event time data, and time-correlated petfood weight data.

The term “feeding event serial number” herein refers to a specifically allocated ranking number of a given feeding event occurring during a feeding trial, enabling one to precisely identify this feeding event among the total number of feeding events having occurred during the feeding trial.

The term “feeding event time data” means herein the time data specifically attached to a given feeding event, e.g., the starting time and the ending time of this feeding event.

The term “time-correlated petfood weight data” herein refers to weight data collected over time in such a way that it makes it possible to associate any weight data with the specifically corresponding time data (in other words, a weight at a time).

The term “feeding trial time data” means herein the time data specifically attached to a feeding trial, e.g., the starting time and the ending time of this feeding trial.

As used herein, the term “pet identification data” means any information enabling one to fully and unambiguously identify a pet involved in a feeding trial. “Pet identification data” include data such as the pet name, breed, weight, age, and the like.

By the term “criteria”, it is herein referred to relevant data obtained through a pet feeding trial and relating to quantitative measurement of consumption of a petfood by a pet. In the context of the present invention, the “criteria” (referred to herein as “crit”) are selected from:
total calorie consumption throughout the feeding trial (tC), i.e., the total of consumed calories by a pet during the complete feeding trial;
duration between the start of the feeding trial and the first feeding event (DFE1);
total number of feeding events with low or no calorie consumption during the feeding trial (NbFElow);
calorie consumption at the first feeding event (CFE1);
calorie consumption per feeding event throughout the feeding trial (CFEₓ); and
cumulative calorie consumption per regular time period throughout the feeding trial (CTP_{y}).

Among the above-listed criteria (“crit”), tC, DFE1, and NbFElow are the main criteria to assess reduced calorie intake while ensuring palatability. CFE1, CFEx, and CTPy are additional criteria, wherein CFE1 is used to assess a satiating but not hypocaloric effect or a hypocaloric (and satiating or not) effect; and CFEₓ and CTP_{y} are optionally used to further characterize the calorie intake reducing effect.

As used herein, the term “feeding event with low or no consumption” means a feeding event wherein a pet consumes less than or equal to 5% of its total daily food requirements based, for example, on recommendations of recognized or competent authorities in the field of pet nutrition (e.g., recommendations of the National Research council (NRC), or the guidelines of the American Association of Feed Control Officials (AAFCO)). Accordingly, when the pet is a cat, a “feeding event with low or no consumption” typically means a feeding event wherein less than or equal to 2 g are consumed by the cat. Advantageously, instead of or in addition to NbFElow, one may calculate the percentage of pets with at least one feeding event with low or no consumption.

Herein, the term “regular time period” refers to a regular time interval, or a regular, homogeneous frequency, or a regular, homogeneous periodicity. For instance, a “regular period of time” is per day, per hour, per minute, and the like. A preferred regular period of time is per hour.

As used herein, “isocaloric” petfoods are petfoods having more or less the same caloric density. In particular, caloric densities may vary from a petfood to another by ±2%, preferably ±1%.

By the term “metabolic weight” or “metabolic body weight”, it is meant herein the body weight raised to some power W^{b} where W equals weight in kilograms and b is an exponent calculated from experimental data. This theoretical exponent can be used to predict the intraspecies relationship of energy to mass. A typical exponent for healthy adult cats and dogs is 0.75.

The “energy requirement” is the energy required to support energy equilibrium over a long period of time. It supports thermal regulation, spontaneous activity and moderate exercise.

“Coating”, as used herein, refers to the topical deposition of a petfood ingredient or a petfood ingredient mixture onto the surface of a petfood preparation, such as by spraying, dusting, and the like.

“Inclusion” as used herein, refers to the addition of a petfood ingredient or a petfood ingredient mixture internally to a petfood preparation, by mixing it with other petfood ingredients, before further processing steps for obtaining the final petfood product (including thermal treatment and/or extrusion and/or retorting, etc.).

As used herein, an “automated pet feeding system”, a “feeding system”, an “automated pet feeding device”, and a “feeding device” are equivalent terms to designate a system or device that is utilized to collect data for use in assessing the behavioral response of a pet towards petfood during a feeding trial.

A “feeding area” is a designated area of a feeding device wherein a petfood is placed in a petfood container.

A “petfood container” refers to any appropriate receptacle for holding a petfood, such as bowls, plates, cups and the like.

An “access detector” refers to a device that indicates the presence of a pet at the feeding device. An “access detector” is capable of detecting the entry of the pets into and their exit from the feeding area. Advantageously, an “access detector” is capable not only of detecting the entry of the pets into and their exit from the feeding area, but also of identifying the pets. Non limiting examples of access detectors include RFID receivers, weight sensors, thermal sensors, and the like.

“Weighing means” refer to a device that continuously measures the weight of a petfood which has been placed in a petfood container in the feeding area of a feeding device. Non-limiting examples of weighing means include balance scales, precision balances, and the like.

A “time collector” is a device capable of providing time information. Examples of time collectors include timers, watches and the like.

An “image collector” is a device that collects image data, reflecting the behavioral response of a pet upon exposure to a petfood placed in a food container in the feeding area. Examples of image data are films, movies, photos, pictures, and the like.

A “data collector” is a device utilized for collecting, recording, and storing data provided by anyone of the access detector, the weighing means, the time collector, and optionally an image collector. Non limiting examples of data collectors include computer software, papers and the like.

A “data processor” is a device dedicated to the calculation of one or more criteria as described herein. Examples of data processor include computer and the like.

As used herein, the term “behavioral response of a pet” refers to an outwardly perceivable action engaged in by a pet in response to being exposed to a petfood. The “behavioral response” may occur prior to, following, or during consumption of the petfood. It should be noted that it is not necessary that consumption of the petfood occurs as a pet may behaviorally respond to a petfood without consuming it. Non-limiting examples of behavioral responses include, the pet licks lips, looks up, shakes head, sits down; the pet moves the petfood out of a petfood container; the pet dribbles petfood on the floor; the pet consumes the petfood; the pet explores the environment within which the feeding device is located; and combinations thereof.

### DESCRIPTION OF THE INVENTION

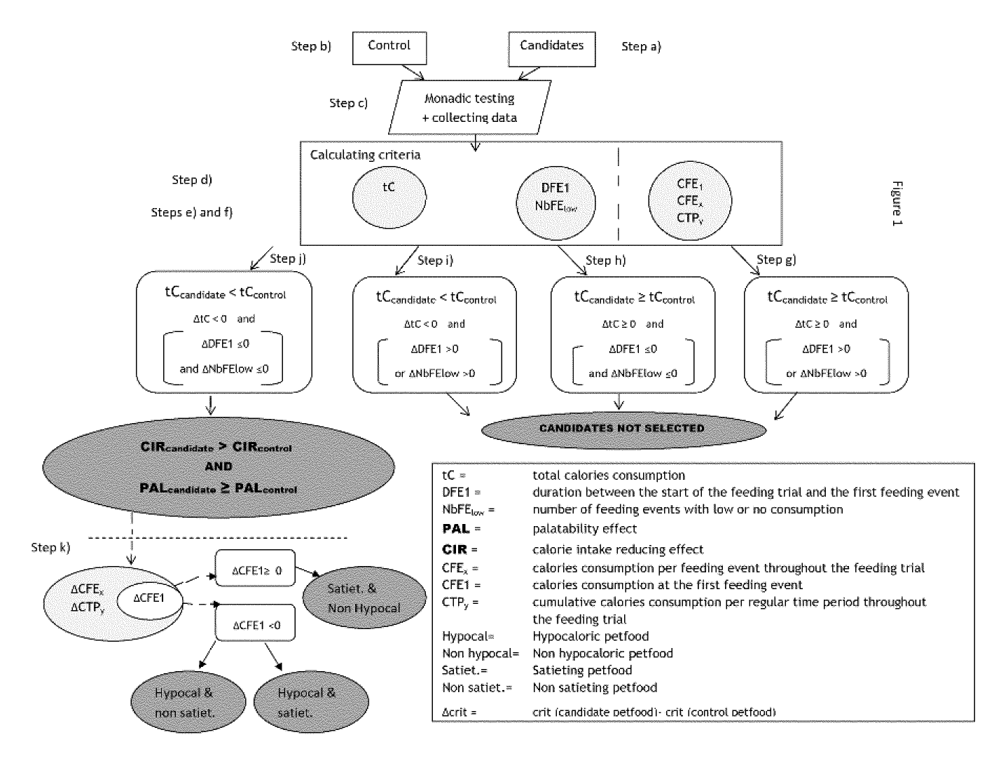

A first aspect of the present invention relates to a method for selecting a petfood having both a palatability effect and a calorie intake reducing effect for pets, comprising (see FIG. 1):

a) providing at least one candidate petfood;
b) providing at least one control petfood having a reference level of both palatability effect and calorie intake;
c) separately testing each petfood of steps a) and b) in a monadic feeding trial, whereby collecting per pet at least:
petfood data, preferably including petfood identification and petfood caloric density;
feeding event data, preferably including feeding event serial number, feeding event time data, and time-correlated petfood weight data;
feeding trial time data; and
pet identification data;
   said method being characterized in that it further comprises:
   d) calculating criteria (crit) per pet and for each petfood, said criteria comprising:
total calorie consumption throughout the feeding trial (tC);
duration between the start of the feeding trial and the first feeding event (DFE1); and
total number of feeding events with low or no consumption during the feeding trial (NbFElow);
and optionally one or more additional criteria selected from:
   calorie consumption at the first feeding event (CFE1);
   calorie consumption per feeding event throughout the feeding trial (CFEₓ); and
   cumulative calorie consumption per regular time period (preferably, per hour) throughout the feeding trial (CTP_{y});
      e) calculating:

Δcrit=crit(candidate petfood)−crit(control petfood) per pet, for the criteria calculated in step d);

f) calculating:
Δcritₘₑₐₙ as a mean of all Δcrits calculated per pet in step e);
g) if ΔtCₘₑₐₙ≥0, and either ΔDFE1ₘₑₐₙ>0 or ΔNbFElowₘₑₐₙ>0, then not selecting the candidate petfood as said candidate petfood has no calorie intake reducing effect for pets (ΔtCₘₑₐₙ≥0) and as it is not as palatable as the control petfood (ΔDFE1ₘₑₐₙ>0 and ΔNbFElowₘₑₐₙ>0); or
h) if ΔtCₘₑₐₙ≥0, ΔDEF1ₘₑₐₙ≤0, and ΔNbFElowₘₑₐₙ≤0, then not selecting the candidate petfood as said candidate petfood has no calorie intake reducing effect for pets (ΔtCₘₑₐₙ≥4) although it is at least as palatable as the control petfood (ΔDFE1ₘₑₐₙ≤0 and ΔNbFElowₘₑₐₙ≤0); or
i) if ΔtCₘₑₐₙ<0, and either ΔDFE1ₘₑₐₙ>0 or ΔNbFElowₘₑₐₙ>0, then not selecting the candidate petfood as said candidate petfood is not as palatable as the control petfood (ΔDFE1ₘₑₐₙ>0 and ΔNbFElowₘₑₐₙ>0) although it has a calorie intake reducing effect for pets (ΔtCₘₑₐₙ<0); or
j) if ΔtCₘₑₐₙ<0, ΔDFE1ₘₑₐₙ≤0, and ΔNbFElowₘₑₐₙ≤0, then selecting the candidate petfood as said candidate petfood has a calorie intake reducing effect for pets (ΔtCₘₑₐₙ<0) and as it is at least as palatable as the control petfood (ΔDFE1ₘₑₐₙ≤0 and ΔNbFElowₘₑₐₙ≤0).

In an embodiment, this method for selecting a petfood having both a palatability effect and a calorie intake reducing effect for pets comprises:

a) providing at least one candidate petfood;
b) providing at least one control petfood having a reference level of both palatability effect and calorie intake;
c) separately testing each petfood of steps a) and b) in a monadic feeding trial, whereby collecting per pet at least:
petfood data, preferably including petfood identification and petfood caloric density;
feeding event data, preferably including feeding event serial number, feeding event time data, and time-correlated petfood weight data;
feeding trial time data; and
pet identification data;
   said method being characterized in that it further comprises:
   d) calculating criteria (crit) per pet and for each petfood, said criteria comprising tC, DFE1, and NbFElow, and optionally one or more additional criteria selected from CFE1, CFEₓ, and CTP_{y};
   e) calculating ΔtC=tC(candidate petfood)−tC(control petfood) per pet;
   f) calculating ΔtCₘₑₐₙ as a mean of all ΔtCs calculated per pet in step e);
   g) or h) as illustrated in FIG. 1, when ΔtCₘₑₐₙ≥0, then concluding that the candidate petfood has no calorie intake reducing effect for pets and thus not selecting the candidate petfood; or
   i) or j) as illustrated in FIG. 1, when ΔtCₘₑₐₙ<0, then concluding that the candidate petfood has a calorie intake reducing effect for pets and thus calculating Δcritₘₑₐₙ as a mean of all Δcrits, wherein Δcrit=crit(candidate petfood)−crit(control petfood) per pet, for the criteria calculated in step d);
if ΔDFE1ₘₑₐₙ>0 or ΔNbFElowₘₑₐₙ>0 (step i) in FIG. 1), then concluding that the candidate petfood is not as palatable as the control petfood, and thus not selecting the candidate petfood; or
if ΔDFE1ₘₑₐₙ≤0 and ΔNbFElowₘₑₐₙ≤0 (step j) in FIG. 1), then concluding that the candidate petfood is at least as palatable as the control petfood and thus selecting the candidate petfood as having both a palatability effect and a calorie intake reducing effect for pets.

In another embodiment, the method for selecting a petfood having both a palatability effect and a calorie intake reducing effect for pets comprises:

a) providing at least one candidate petfood;
b) providing at least one control petfood having a reference level of both palatability effect and calorie intake;
c) separately testing each petfood of steps a) and b) in a monadic feeding trial, whereby collecting per pet at least:
petfood data, preferably including petfood identification and petfood caloric density;
feeding event data, preferably including feeding event serial number, feeding event time data, and time-correlated petfood weight data;
feeding trial time data; and
pet identification data;
   said method being characterized in that it further comprises:
   d) calculating criteria (crit) per pet and for each petfood, said criteria comprising total calorie consumption throughout the feeding trial (tC), DFE1, and NbFElow, and optionally one or more additional criteria selected from CFE1, CFEₓ, and CTP_{y};

e) calculating Δcrit=crit(candidate petfood)−crit(control petfood) per pet, for the criteria calculated in step d);

f) calculating Δcritₘₑₐₙ as a mean of all Δcrits calculated per pet in step e);
g) or i) as illustrated in FIG. 1, when ΔDFE1ₘₑₐₙ>0 or ΔNbFElowₘₑₐₙ>0, then concluding that the candidate petfood is not as palatable as the control petfood, and thus not selecting the candidate petfood; or
h) or j) as illustrated in FIG. 1, when ΔDFE1ₘₑₐₙ≤0 and ΔNbFElowₘₑₐₙ≤0, then concluding that the candidate petfood is at least as palatable as the control petfood and calculating ΔtCₘₑₐₙ as a mean of all ΔtCs, wherein ΔtC=tC(candidate petfood)−tC(control petfood) per pet;
if ΔtCₘₑₐₙ≥0 (step h) as illustrated in FIG. 1), then concluding that the candidate petfood has no calorie intake reducing effect for pets and thus not selecting the candidate petfood; or
if ΔtCₘₑₐₙ<0 (step j) as illustrated in FIG. 1), then concluding that the candidate petfood has a calorie intake reducing effect for pets and thus selecting the candidate petfood as having both a palatability effect and a calorie intake reducing effect for pets.

An appropriate kinetic-based procedure for performing a monadic feeding trial is as follows.

### Operating Method of the Test for the Evaluation of One Petfood

the food is weighed out and placed in feeding bowls. The amount offered enables the daily energy requirements of the pets to be met.
The bowl is presented to the pets in a feeding system comprising all necessary equipment to collect and preferably record the relevant data.
Pets have free access to the distributed food and free access to drinking water throughout the duration of the test.
For one petfood, the feeding trial can last from 10 minutes to 24 hours, depending on protocols, and can be repeated over several days and/or several times per day.
Only one petfood is available to the pets per day of the test
Food is replaced with fresh food at the beginning of every feeding trial.

### Operating Method of the Test, for the Evaluation of Two or More Petfoods

The procedure for the evaluation of one petfood is repeated in an identical manner for the evaluation of the second petfood.

Ideally, before starting any petfood evaluation, the pets are split in two groups, such that one group receives the control petfood and the other group receives the candidate petfood; in the second part of the procedure, the petfood allocation is inverted and the test is then repeated.

### Parameters Studied

quantities of petfood consumed and temporal data associated with these quantities.

### Statistical Analysis

For comparing results obtained for different petfoods, a statistical analysis is performed, preferably a parametric analysis, yet preferably an analysis of variance with mixed effects if data are quantitative and a polytomic logistic regression with mixed effects if data are qualitative. Typically, a student's T-test for quantitative data or a chi² for qualitative data is done from these models to study the differences of each criterion for one candidate petfood against the control petfood.

Typical significance levels for statistical tests are noted as below:

| | | |
|---|---|---|
| NS | not significant | (p > 0.05) |
| * | significant | (p ≤ 0.05) |
| ** | highly significant | (p ≤ 0.01) |
| *** | very highly significant | (p ≤ 0.001). |

In step c) of the method of selection according to the present invention, among the thus collected petfood data, petfood caloric density is considered. Since petfood caloric density includes metabolizable energy (ME), one can directly consider ME instead of petfood caloric density.

The method of selection according to the present invention makes it possible to provide relevant data through quantitative measurement of consumption of a petfood by a pet. Non-limiting examples of consumption data include total amount of petfood consumed in a given time period; total amount of petfood consumed in a feeding event; average amount of petfood consumed in multiple feeding events; duration of time a pet is at the feeding device; number of feeding events in a given time period; rate of consumption; rate of consumption at the first feeding event in a given time period; duration of time until the first feeding event in a given time period; total duration of time a pet is at the feeding device in a given time period; and combinations thereof. Consumption data related to weight measurements are collected through the use of weighing means. Consumption data related to time measurements are collected through the use of a time collector. Typically, the consumption data may be imprinted onto a tangible medium such as, but not limited to, paper, computer software, and memory devices.

Δcritₘₑₐₙ is calculated in the method of selection according to the present invention for tC and two other criteria: DFE1 and NbFElow.

In particular, the candidate petfood is not selected in the method of selection according to the present invention if at least one of the two conditions ΔDFE1ₘₑₐₙ>0 and ΔNbFElowₘₑₐₙ>0 is fulfiled.

Yet in particular, the candidate petfood is selected in the method of selection according to the present invention if the two conditions ΔDFE1ₘₑₐₙ≤0 and ΔNbFElowₘₑₐₙ≤0 are fulfilled, provided ΔtC<0.

Preferably, Δcritₘₑₐₙ is calculated for tC and three other criteria: DFE1 and NbFElow and the additional criterion CFE1.

In an embodiment of the method of selection according to the present invention, tC is calculated per pet as follows:

tC=(W0−Wf)×ME,

with W0: weight of the petfood at the start of the feeding trial,
Wf: weight of the petfood at the end of the feeding trial, and
ME: metabolic energy (expressed in Kcal/weight unit);
and wherein W0 and Wf are data collected in step c).

In an embodiment of the method of selection according to the present invention, DFE1 is calculated per pet as follows:

DFE1=Tfe1−T0,

with T0: starting time of the feeding trial, and
Tfe1: starting time of the first feeding event,
and wherein T0 and Tfe1 are data collected in step c).

In an embodiment, the method of selection according to the present invention further comprises at least the step of characterizing the calorie intake reducing effect for pets of said candidate petfood selected in step j) by:

k) calculating Δcritₘₑₐₙ as a mean of all Δcrits, wherein Δcrit=crit(candidate petfood)−crit(control petfood) per pet, for at least one of the additional criteria measured in step d), wherein said at least one criterion is selected from CFE1, CFEₓ and CTP_{y}.

Preferably, Δcritₘₑₐₙ is calculated in step k) above for two of the additional criteria selected from CFE1, CFEₓ and CTP_{y}. Yet preferably, Δcritₘₑₐₙ is calculated in step k) above for the three additional criteria CFE1, CFEₓ and CTP_{y}.

In an embodiment, CFE1 is calculated per pet as follows:

CFE1=(Wfe0−Wfe1)×ME,

with Wfe0=W0: weight of the petfood at the start of the feeding trial,
Wfe1: weight of the petfood after the first feeding event, and
ME: metabolic energy (expressed in Kcal/weight unit);
and wherein W0 and Wfe1 are data collected in step c).

Thus, CFE1 as calculated in step k) characterizes the calorie intake at the first feeding event. CFE1 is a key criterion to distinguish a satiating effect from a hypocaloric effect. Indeed, the consumption of a hypocaloric food leads to a decrease of calorie intake as early as within the first feeding event. On the contrary, consumption of a satiating food usually leads to a gradual decrease of calorie intake, the satiating effect resulting from biological mechanisms, appearing after FE1.

In an embodiment, CFEₓ is calculated per pet in the method of the present invention as follows:

CFEₓ=(Wfeₓ₋₁−Wfeₓ)×ME,

with Wfeₓ: weight of the petfood after the feeding event x,
Wfeₓ₋₁: weight of the petfood after the feeding event x-1,
ME: metabolic energy (expressed in Kcal/weight unit),
x representing a feeding event, x-1 representing the feeding event immediately before the feeding event x, x being from 1 to N, and N being the total number of feeding events during the feeding trial,
and wherein Wfeₓ, Wfeₓ₋₁, and N are data collected in step c).

Thus, ΔCFEₓ as calculated in step k) characterizes the difference in consumption per feeding event for all feeding events, giving thereby an indication of the distribution of the quantities eaten throughout these feeding events.

In an embodiment, CTP_{y} is calculated per pet in the method of the present invention as follows:

CTP_{y}=(W0−Wtp_{y})×ME,

with W0: weight of the petfood at the start of the feeding trial,
Wtp_{y}: weight of the petfood at the end of the time period y,
ME: metabolic energy (expressed in Kcal/weight unit),
y representing a time period, y being from 1 to P, and P being the total number of time periods regularly dividing the total duration of the feeding trial (tD),
wherein tD=Tfin−T0,
with T0: starting time of the feeding trial, and
Tfin: ending time of the feeding trial,
and wherein Wtp_{y}, T0, and Tfin are data collected in step c).

Thus, ΔCTP_{y} as calculated in step k) characterizes the differences in cumulative consumption for two petfoods at each time-point of the test, giving thereby an indication of the duration between the start of the test and the time at which a difference in consumption between both petfoods becomes significant.

In an embodiment of the method of selection according to the present invention, anyone of tC, CFE1, CFEₓ, and CTP_{y} is expressed in calories or Joules. Alternatively, anyone of tC, CFE1, CFEₓ, and CTP_{y} is expressed in any unit selected from grams, calories, and Joules when said candidate petfood and said control petfood are isocaloric.

In an embodiment of the method of selection according to the present invention, anyone of tC, CFE1, CFEₓ, and CTP_{y} can be expressed per any unit selected from pet, kg of body weight, and kg of metabolic weight.

Preferably, the serving order of the petfood is balanced during the feeding trial of step c) of the method of selection according to the present invention. This means that, in practice, each possible serving order should be used equally. In an embodiment, the presentation order is randomized for each petfood during the feeding trial.

In an embodiment, the method of selection according to the present invention further comprises a step of performing a palatability characterization via any appropriate method, e.g., one or more versus tests, monadic tests, in-home consumer tests, and the like, which are well known to those skilled in the art.

In an embodiment, the method of selection according to the present invention further comprises at least the following steps before step a):
formulating a candidate petfood ingredient mixture as said candidate petfood provided in step a); and
formulating a control petfood ingredient mixture as said control petfood provided in step b).

Such a petfood ingredient mixture corresponds thus, one formulated, to a petfood preparation, i.e., a combination of ingredients in appropriate amounts according to a petfood recipe, so as to obtain a petfood matrix or a petfood basal composition. A petfood preparation may thus be final, i.e., a complete combination of all the required ingredients in appropriate amounts according to the recipe. Alternatively, a petfood preparation may be incomplete as it may lack one or more ingredients to be complete and final. In the present disclosure, the one of ordinary skill in the art will of course clearly and unambiguously distinguish the embodiments wherein the petfood preparation is final and the embodiments wherein the petfood preparation is incomplete.

Petfoods represent a nutritionally balanced mixture containing proteins, fibres, carbohydrates and/or starch, fats. Such mixtures are well known to those skilled in the art, and their composition/formulation depends on many factors such as, for example, the desired food balance for the specific category of pets. In addition to these base elements, the food may include vitamins, minerals, and other additives such as seasonings, preservatives, and the like. Specific suitable amounts for each component in a food composition will depend on a variety of factors such as the species of pet consuming the composition, the particular components included in the composition, the age, weight, general health of the pet, and the like. Therefore, the component amounts may vary from one embodiment to another. The food balance, including the relative proportions of vitamins, minerals, lipids, proteins, and carbohydrates, is determined according to the known dietary standards in the veterinary field, for example by following recommendations of the National Research council (NRC), or the guidelines of the American Association of Feed Control Officials (AAFCO).

All conventional protein sources may be used, obtained from a variety sources such as plants, animals, or both. Animal proteins include poultry meal, meat meal, and bone meal, fish meal, casein, egg powder, albumin, and fresh animal tissue, for example fresh meat tissue and fresh fish tissue. Plant proteins include gluten, wheat protein, soy protein, rice protein, corn protein, and the like. Other types of proteins include microbial proteins such as yeast.

The fat and carbohydrate food ingredient is obtained from a variety of sources such as animal fat, fish oil, vegetable oil, meat, meat by-products, grains, other animal or plant sources, and mixtures thereof. Grains include wheat, corn, barley, rice, and the like. The fiber food ingredient is obtained from a variety of sources such as vegetable fiber sources, e.g., cellulose, beet pulp, peanut hulls, and soy fiber.

The food preparations may contain additional components such as vitamins, minerals, fillers, palatability enhancers, stabilizers, texturing agents, coatings, and the like, well known to the skilled artisan. Therefore, the component amounts may vary from one embodiment to another.

For example here, when one sample of a petfood preparation is formulated in such a way to obtain a candidate petfood, another sample can be formulated another way to obtain a control petfood. As an illustration, if one sample of a petfood preparation is formulated to obtain a candidate petfood using satiety inducing agents and/or with a low fat level, another sample can be formulated in such a way to obtain a control petfood without any satiety inducing agents and/or with a higher fat level compared to the candidate petfood.

Thus, yet in this embodiment, the method of selection according to the present invention in particular further comprises at least the following steps before step a):
providing at least two samples of a petfood preparation;
incorporating a candidate petfood ingredient in one sample of said petfood preparation, thereby obtaining said candidate petfood provided in step a); and
using another sample of said petfood preparation as said control petfood provided in step b).

In an alternative or cumulative embodiment, the method of selection according to the present invention further comprises at least the following steps before step a):
providing at least two samples of a petfood preparation;
processing one sample of said petfood preparation, thereby obtaining said candidate petfood provided in step a); and
processing differently another sample of said petfood preparation, thereby obtaining said control petfood provided in step b).

A sample of a petfood preparation can be processed various ways according to the common knowledge in the art.

Dry pet foods are commonly prepared by different methods. One of these methods, that is widely used, is a cooker-extruder method. Dry ingredients, including animal protein sources, plant protein sources, grains, etc., are ground and mixed together. Moist or liquid ingredients, including fats, oils, animal protein sources, water, etc., are then added to and mixed with the dry mix. The mixture is then processed into kibbles or similar dry pieces. Kibble is often formed using an extrusion process in which the mixture of dry and wet ingredients is subjected to mechanical work at a high pressure and temperature, and forced through small openings or dies and cut off into kibble by a rotating knife. This die forms the extruded product into a specific shape. The wet kibble is then dried in a hot air dryer. Generally, the product is dried until it contains less than 14% moisture, and typically about 5 to 10% moisture. The dried particles or pieces are then transferred by conveyor to a coating system and sprayed with fat and/or liquid palatability enhancers. Particles can optionally be coated with one or more topical coatings, which may include palatability enhancers, powders, and the like.

Wet pet foods such as ground loaf product are generally prepared by mixing the various components, for example, water, meats, grains, vitamins, minerals, palatability enhancers, and the like. The solid materials are previously ground together. The resulting mixture is processed and filled in the cans or aluminium trays, seamed and retorted at a time and a temperature to cook and sterilize the product. The “loaf” finished product generally has a moisture range of about 65% to about 85%.

Wet pet foods such as chunks in jelly or in gravy are generally prepared by mixing the various components, for example, water, meats, grains, vitamins, minerals, palatability enhancers, and the like. Solid materials are previously ground together. The resulting mixture is processed by cooking and cutting into pieces. Separately, a jelly or a gravy is prepared by mixing various components, for example, water, colorants, palatability enhancers, texturing agents, etc. Then, the pieces and the jelly or gravy are processed and filled in cans or pouches or aluminium trays in different proportions, depending on the recipe. The cans or pouches are seamed and retorted at a time and a temperature to cook and sterilize the product. The finished product “chunks in jelly” or “chunks in gravy” generally has a moisture range of about 65% to about 85%.

Thus, in this embodiment, when one sample of the petfood preparation is processed one way to obtain the candidate petfood, another sample is processed another way (“processed differently”) to obtain the control petfood. For example, if one sample of the petfood preparation is extruded in such a way to obtain the control petfood with a given bulk density, another sample is extruded in such a way to obtain the candidate petfood with a lower bulk density than the control petfood.

Another aspect of the present invention relates to a method for selecting a petfood having both a palatability effect and a hypocaloric effect for pets, comprising at least:
performing the method of selection as described above including calculation of CFE1 and ΔCFE1 and ΔCFE1ₘₑₐₙ; and
if ΔtCₘₑₐₙ<0 and ΔDFE1ₘₑₐₙ≤0 and ΔNbFElowₘₑₐₙ≤0 and ΔCFE1ₘₑₐₙ<0, then selecting the candidate petfood as said candidate petfood has a hypocaloric effect for pets and as it is at least as palatable as the control petfood.

The hereby selected candidate petfood has a hypocaloric effect for pets, whatever its satiating properties.

This means that the thus selected candidate petfood can be either hypocaloric and satiating or hypocaloric and not satiating.

Yet another aspect of the present invention is directed to method for selecting a petfood having both a palatability effect and a satiating but not hypocaloric effect for pets, comprising at least:
performing the method of selection as described above including calculation of CFE1 and ΔCFE1 and ΔCFE1ₘₑₐₙ; and
if ΔtCₘₑₐₙ<0 and ΔDFE1ₘₑₐₙ≤0 and ΔNbFElowₘₑₐₙ≤0 and ΔCFE1ₘₑₐₙ≥0, then selecting the candidate petfood as said candidate petfood has a satiating but not hypocaloric effect for pets and as it is at least as palatable as the control petfood.

Another aspect of the present invention concerns a method for preparing a petfood having both a palatability effect and a calorie intake reducing effect for pets.

In an embodiment, the method of preparation according to the present invention comprises at least:
performing a method of selection as described above, thereby selecting a candidate petfood ingredient mixture having both a palatability effect and a calorie intake reducing effect (in particular a hypocaloric effect or a satiating but not hypocaloric effect) for pets; and
incorporating said thus selected candidate petfood ingredient mixture in a petfood preparation, thereby obtaining said petfood having both a palatability effect and a calorie intake reducing effect for pets.

Preferably, said candidate petfood ingredient mixture is incorporated by inclusion in said petfood preparation. Alternatively, said candidate petfood ingredient mixture is incorporated by coating said petfood preparation.

In an alternative embodiment, the method of preparation according to the present invention comprises at least:
performing a method of selection as described above, thereby selecting a candidate petfood ingredient having both a palatability effect and a calorie intake reducing effect (in particular a hypocaloric effect or a satiating but not hypocaloric effect) for pets; and
incorporating said thus selected candidate petfood ingredient in a petfood preparation, thereby obtaining said petfood having both a palatability effect and a calorie intake reducing effect for pets.

Preferably, said candidate petfood ingredient is incorporated by inclusion in said petfood preparation. Alternatively, wherein said candidate petfood ingredient is incorporated by coating said petfood preparation.

Yet another aspect of the present invention concerns a method for feeding a pet with a petfood having both a palatability effect and a calorie intake reducing effect for pets, said method comprising at least:
performing a method of selection as described above, thereby selecting a candidate petfood having both a palatability effect and a calorie intake reducing effect (in particular a hypocaloric effect or a satiating but not hypocaloric effect) for pets; and
feeding said pet with said petfood.

A further aspect of the present invention relates to an automated pet feeding system for use in a pet feeding trial as defined in a method of selection as described above, comprising:
a feeding area comprising a petfood container;
an access detector for detecting and identifying a pet using the feeding area;
weighing means for weighing the amount of petfood consumed by a pet in the feeding area;
a time collector;
a data collector for collecting and recording data provided by anyone of the access detector, the weighing means, and the time collector; and
a data processor for at least calculating tC and crit as defined previously.

In an embodiment, the feeding device is associated with hardware and software for the storage of feeding trial data. The association may be through network interface or wireless connectivity.

In practice, a petfood is placed in a petfood container in the feeding area, allowing consumption of the petfood by a pet having entered the petfood area.

In all aspects and embodiments of the present invention, the petfoods (candidate(s) and control(s)) are dry and wet, and are preferably dry.

Yet in all aspects and embodiments of the present invention, the pets are selected from cats and dogs, and are preferably cats.

The present invention will be further described by reference to the following examples, which are presented for the purpose of illustration only and are not intended to limit the scope of the invention.

### EXAMPLES

### Theoretical Example

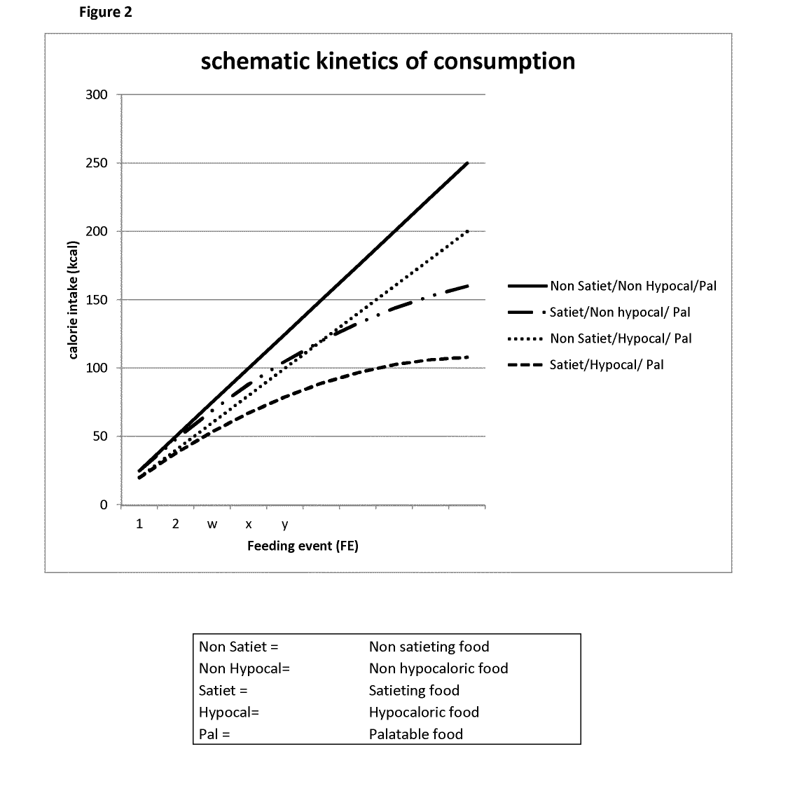

FIG. 2 illustrates schematically the theoretical kinetics of consumption of 4 different petfoods based on their palatability and calorie intake reducing effects.
The “non satiating/non hypocaloric/palatable” food is a control diet whose consumption is linear throughout the feeding trial.
The “non satiating/hypocaloric/palatable” food gets a linear curve too, but the calorie intake is reduced compared to the control, and this, as early as within the first feeding event.
The “satiating/non hypocaloric/palatable” food presents a decrease in caloric intake compared to the control, appearing after a period of time that can be measured.
The “satiating/hypocaloric/palatable” food shows a decrease of calorie intake very quickly after the start of the feeding trial due to the hypocaloric effect, this decrease being more pronounced over time, due to the co-existence of a satiating effect.

### Example 1

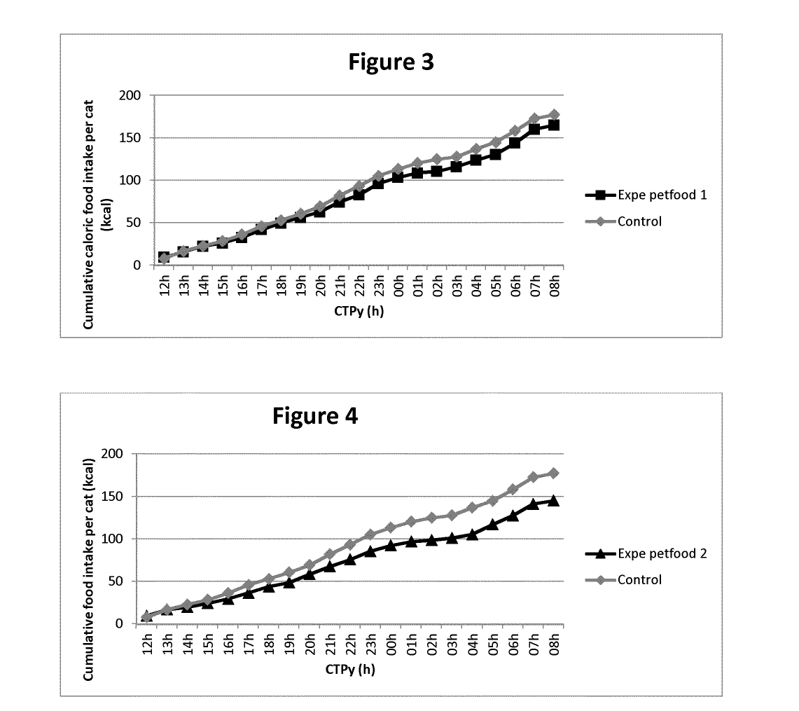

A nutritionally-balanced dry food composition (hereinafter referred to as “Control petfood A”), suitable for consumption by cats and obtained after an extrusion and drying process, was prepared. Its metabolizable energy value was 3563 Kcal/Kg. The Control petfood A was known to be a palatable petfood.
Experimental petfood 1, a nutritionally-balanced dry food suitable for consumption by cats and obtained after an extrusion and drying process, was prepared. Its formulation differed from that of Control petfood A by adding a satiating agent. The metabolizable energy value of Experimental petfood 1 was 3367 Kcal/Kg.
Experimental petfood 2, a nutritionally-balanced dry food composition suitable for consumption by cats and obtained after an extrusion and drying process, was prepared. Its formulation differed from those of Control petfood A and Experimental petfood 1 by adding another satiating agent. The metabolizable energy value of Experimental petfood 2 was 3314 Kcal/Kg.
All three petfoods were coated with 2% of the same dry palatability enhancer.
A feeding trial was performed in a randomized monadic way, with the 3 different petfoods. Each petfood was offered in a single bowl, in a balanced serving order, and tested by a panel of 72 cats during 20 hours. Data were collected as described in the present invention. Tests began at 11 o'clock.
As shown in Tables 3 and 4 below, the total calories consumptions tCs, calculated as a mean over all pets of the individual total calories consumptions per cat, were significantly different between Control petfood A and Experimental petfood 2, but not between Control petfood A and Experimental petfood 1. This showed that Experimental petfood 2 had a calorie intake reducing effect compared to Control petfood A, which was not the case of Experimental petfood 1.
In order to establish if Experimental petfoods 1 and 2 were as palatable as Control petfood A, different criteria were measured: DFE1, and NbFElow. The results in Tables 3 and 4 showed that no statistically significant differences were observed between either Control petfood A and Experimental petfood 1 or Control A and Experimental petfood 2. This demonstrated that Experimental petfood 1 and Experimental petfood 2 were as palatable as Control petfood A.
In this trial, only Experimental petfood 2 could be selected because it fulfilled both conditions: to have a palatability level similar to that of control petfood A and a calorie intake reducing effect compared to Control petfood A.
Additional data were analyzed: CFE1, CFEx, and CTPy. As shown in Tables 5 and 6 below, CFE1 was not significantly different between Experimental petfood 2 and Control petfood A, showing that the caloric intake reducing effect of Experimental petfood 2 is due to a satiating effect and not an hypocaloric effect. A study of CFEx gives more information about this satiating effect. Indeed, CFE3 was significantly different between Experimental petfood 2 and Control petfood A so the calorie intake of Experimental petfood 2 was lower compared to that of Control petfood A at this feeding event. This gives an indication that the calorie intake reducing effect of Experimental petfood 2 is not immediate since it really becomes significant as of the third feeding event.
As shown in Tables 7 and 8 below, Experimental petfood 2 became significantly less consumed than Control petfood A at the period of time between 15-16 h o'clock, which was 6 hours after the beginning of the test. This difference in cumulative calorie intakes remained statistically significant for the remaining time of the test and increased at each time period, yielding a final difference which was highly significant (see Table 7). This kinetic of calorie intake may yield information as to the mechanism of action of the satiating agent.
As an illustration, FIG. 3 is the kinetics of consumption of Control petfood A and Experimental petfood 1 (“Expe petfood 1”), and FIG. 4 the kinetics of consumption of Control petfood A and Experimental petfood 2 (“Expe petfood 2”).

TABLE 3
Mean results for criteria tC, DFE1, and NbFElow (for all pets)

| | | DFE1 | NbFE low |
|---|---|---|---|
| PRODUCT | tC (kcal) | (minutes) | (≤2 g) |
| Control petfood A | 177.16 | 96.83 | 0.8768 |
| Experimental petfood 1 | 164.66 | 110.56 | 0.8189 |
| Experimental petfood 2 | 144.90 | 99.29 | 0.8768 |

TABLE 5
Mean results for the additional criterion CFEx, and
particularly CFE1 (for all pets)

| Consumption per feeding | | | | | | | | |
|---|---|---|---|---|---|---|---|---|
| event (Kcal) | CFE 1 | CFE 2 | CFE 3 | CFE 4 | CFE 5 | CFE 6 | CFE 7 | CFE 8 |
| Control petfood A | 24.83 | 26.94 | 27.54 | 25.13 | 27.90 | 23.58 | 24.98 | 18.58 |
| Experimental petfood 1 | 24.66 | 25.47 | 25.20 | 25.40 | 24.45 | 24.37 | 19.81 | 20.87 |
| Experimental petfood 2 | 25.07 | 24.93 | 22.57 | 21.74 | 21.21 | 19.39 | 19.21 | 22.30 |

TABLE 7
Mean results for the additional criterion CTPy (for all pets)

| | CTP1 | CTP2 | CTP3 | CTP4 | CTP5 | CTP6 | CTP7 | CTP8 | CTP9 | CTP10 | CTP11 |
|---|---|---|---|---|---|---|---|---|---|---|---|
| | mean | mean | mean | mean | mean | mean | mean | mean | mean | mean | mean |
| Time period | 11-12 h | 12-13 h | 13-14 h | 14-15 h | 15-16 h | 16-17 h | 17-18 h | 18-19 h | 19-20 h | 20-21 h | 21-22 h |
| Control petfood A | 8.0 | 16.6 | 22.8 | 28.3 | 36.2 | 45.8 | 52.8 | 60.4 | 69.2 | 81.9 | 93.3 |
| Experimental petfood 1 | 9.4 | 15.7 | 22.3 | 26.0 | 32.7 | 41.9 | 49.5 | 56.1 | 62.8 | 74.3 | 82.7 |
| Experimental petfood 2 | 9.5 | 16.7 | 19.8 | 24.3 | 29.4 | 36.4 | 43.7 | 48.4 | 58.5 | 67.4 | 75.7 |
| Stat Sign | NS | NS | NS | NS | NS | * | * | ** | NS | * | ** |

| | CTP12 | CTP13 | CTP14 | CTP15 | CTP16 | CTP17 | CTP18 | CTP19 | CTP20 | CTP21 |
|---|---|---|---|---|---|---|---|---|---|---|
| | mean | mean | mean | mean | mean | mean | mean | mean | mean | mean |
| | 22- | 23- | 00- | 01- | 02- | 03- | 04- | 05- | 06- | 07- |
| Time period | 23 h | 00 h | 010 h | 021 h | 03 h | 04 h | 05 h | 06 h | 07 h | 08 h |
| Control petfood A | 105.3 | 113.3 | 120.2 | 124.9 | 127.7 | 136.8 | 144.8 | 158.2 | 172.5 | 177.1 |
| Experimental petfood 1 | 96.0 | 103.3 | 108.5 | 110.4 | 115.8 | 123.6 | 130.4 | 143.8 | 160.0 | 164.7 |
| Experimental petfood 2 | 85.3 | 92.2 | 96.8 | 98.4 | 100.8 | 105.1 | 116.9 | 127.6 | 141.1 | 144.9 |
| Stat Sign | ** | ** | *** | *** | *** | *** | *** | *** | *** | *** |

### Example 2

A nutritionally-balanced dry food composition (hereinafter referred to as “Control petfood B”), suitable for consumption by cats and obtained after an extrusion and drying process, was commercially purchased. The Control petfood B is commercially proposed as a maintenance petfood for adult cats and it is known to be palatable. Its metabolizable energy value was 3738 Kcal/Kg.
Experimental petfood 3, a nutritionally-balanced dry food composition suitable for consumption by cats and obtained after an extrusion and drying process, was commercially purchased. This commercial petfood is proposed to reduce or control obesity in cats. Its formulation differed from that of Control petfood B. The metabolizable energy value of Experimental petfood 3 was 3595 Kcal/Kg.
A feeding trial was performed in a randomized monadic way, with the 2 different petfoods. Each petfood was offered in a single bowl, in a balanced serving order, and tested by a panel of 37 cats during 20 hours. Data were collected as described in the present invention.
As shown in Tables 9 and 10 below, the total calories consumption tCs, calculated as a mean over all pets of the individual total calories consumptions per cat, were significantly different between Control petfood B and Experimental petfood 3. This showed that Experimental petfood 3 had a calorie intake reducing effect compared to Control petfood B.
In order to establish if Experimental petfood 3 was as palatable as Control petfood B, different criteria were measured: DFE1, and NbFElow. The results in Tables 9 and 10 showed that statistical significant differences were observed between Control petfood B and Experimental petfood 3 on NbFElow (but not on DFE1). This demonstrated that Experimental petfood 3 was less palatable than Control petfood B.
In this trial, Experimental petfood 3 could not be selected because it did not fulfill one condition: to be at least as palatable as Control petfood B.

TABLE 9
Mean results for criteria tC, DFE1, and NbFElow (for all pets)

| | | DFE1 | NbFE low |
|---|---|---|---|
| PRODUCT | tC(kcal) | (minutes) | (≤2 g) |
| Control petfood B | 189.75 | 90.08 | 0.2911 |
| Experimental petfood 3 | 148.52 | 95.83 | 0.7776 |

### Example 3

A nutritionally-balanced dry food composition (hereinafter referred to as “Control petfood C”), suitable for consumption by cats and obtained after an extrusion and drying process, was commercially purchased. The Control petfood C is commercially proposed as a maintenance petfood for adult cats and it is known to be palatable. Its metabolizable energy value was 4168 Kcal/Kg.
Experimental petfood 4, a nutritionally-balanced dry food composition suitable for consumption by cats and obtained after an extrusion and drying process, was commercially purchased. This commercial petfood is proposed to reduce the caloric intake of the cats by reducing the metabolizable energy. Its formulation differed from that of Control petfood C. The metabolizable energy value of Experimental petfood 4 was 3484 Kcal/Kg (16% less than Control petfood C).
A feeding trial was performed in a randomized monadic way, with the 2 different petfoods. Each petfood was offered in a single bowl, in a balanced serving order, and tested by a panel of 40 cats during 20 hours. Data were collected as described in the present invention.
As shown in Tables 11 and 12 below, the total calories consumption tCs, calculated as a mean over all cats of the individual total calories consumptions per cat, were significantly different between Control petfood C and Experimental petfood 4. This showed that Experimental petfood 4 had a calorie intake reducing effect compared to Control petfood C.
In order to establish if Experimental petfood 4 was as palatable as Control petfood C, two criteria were measured: DFE1 and NbFElow. The results in Tables 11 and 12 showed that no statistical significant differences were observed between Control petfood C and Experimental petfood 4. This demonstrated that Experimental petfood 4 was as palatable as Control petfood C.
In order to distinguish a hypocaloric effect from a satiating and/or hypocaloric effect, additional data were analyzed: CFE1, CFEx and CTPy. As shown in Tables 13 and 14 below, CFE1 was significantly different between Experimental petfood 4 and Control petfood C. This shows that the caloric intake reducing effect of Experimental petfood 4 is due to a hypocaloric effect, with a caloric intake reduction appearing as early as within the first feeding event (FE1). A study of CFEx gives additional information. CFE2 and CFE3 were significantly different between Experimental petfood 4 and Control petfood C, showing that the hypocaloric effect of Experimental petfood 4 was very pronounced in the first three feeding events. This result allows to conclude to a strong and early calorie intake reducing effect of Experimental petfood 4 that can be classified as a real hypocaloric and palatable food.

TABLE 11

| Mean results for criteria tC and NbFElow (for all pets) | | | |
|---|---|---|---|
| | | DFE1 | NBFE low |
| PRODUCT | tC(kcal) | (minutes) | (≤2 g) |
| Control petfood C | 239.40 | 120.2 | 0.375 |
| Experimental petfood 4 | 203.77 | 108.64 | 0.475 |

TABLE 13
Mean results for the additional criterion CFEx which includes CFE1

| Consumption per | | | | | | | | |
|---|---|---|---|---|---|---|---|---|
| feeding event (Kcal) | CFE 1 | CFE 2 | CFE 3 | CFE 4 | CFE 5 | CFE 6 | CFE 7 | CFE 8 |
| Control petfood C | 52.46 | 44.65 | 38.92 | 34.34 | 32.78 | 42.47 | 27.84 | 29.87 |
| Experimental petfood 4 | 32.79 | 34.67 | 30.24 | 29.64 | 30.03 | 24.80 | 25.00 | 22.47 |

1-11. (canceled)

12. A method for selecting a petfood having both a palatability effect and a calorie intake reducing effect for pets comprising:
a) providing at least one candidate petfood;
b) providing at least one control petfood having a reference level of both palatability effect and calorie intake;
c) separately testing each petfood of steps a) and b) in a monadic feeding trial, whereby collecting per pet at least:
petfood data;
feeding event data;
feeding trial time data; and
pet identification data;
said method being characterized in that it further comprises:
d) calculating criteria (crit) per pet and for each petfood, said criteria comprising:
total calorie consumption throughout the feeding trial (tC);
duration between the start of the feeding trial and the first feeding event (DFE1); and
total number of feeding events with low or no consumption during the feeding trial (NbFElow);
and optionally one or more additional criteria selected from:
calorie consumption at the first feeding event (CFE1);
calorie consumption per feeding event throughout the feeding trial (CFEₓ); and
cumulative calorie consumption per regular time period throughout the feeding trial (CTP_{y});
e) calculating:
Δcrit=crit(candidate petfood)−crit(control petfood) per pet, for the criteria calculated in step d);
f) calculating:
Δcritₘₑₐₙ as a mean of all Δcrits calculated per pet in step e);
g) if ΔtCₘₑₐₙ≥0, and either ΔDFE1ₘₑₐₙ>0 or ΔNbFElowₘₑₐₙ>0, then not selecting the candidate petfood as said candidate petfood has no calorie intake reducing effect for pets and as it is not as palatable as the control petfood; or
h) if ΔtCₘₑₐₙ≥0, ΔDFE1ₘₑₐₙ≤0 and ΔNbFElowₘₑₐₙ≤0, then not selecting the candidate petfood as said candidate petfood has no calorie intake reducing effect for pets although it is at least as palatable as the control petfood; or
i) if tCₘₑₐₙ<0, and either ΔDFE1ₘₑₐₙ>0 or ΔNbFElowₘₑₐₙ>0, then not selecting the candidate petfood as said candidate petfood is not as palatable as the control petfood although it has a calorie intake reducing effect for pets; or
j) if ΔtCₘₑₐₙ<0, ΔDFE1ₘₑₐₙ≤0 and ΔNbFElowₘₑₐₙ≤0, then selecting the candidate petfood as said candidate petfood has a calorie intake reducing effect for pets and as it is at least as palatable as the control petfood.

13. The method according to claim 12, wherein tC is calculated per pet as follows:
tC=(W0−Wf)×ME,
with W0: weight of the petfood at the start of the feeding trial,
Wf: weight of the petfood at the end of the feeding trial, and
ME: metabolizable energy (expressed in Kcal/weight unit);
and wherein W0 and Wf are data collected in step c).

14. The method according to claim 12, wherein DFE1 is calculated per pet as follows:
DFE1=Tfe1−T0,
with T0: starting time of the feeding trial, and
Tfe1: starting time of the first feeding event,
and wherein T0 and Tfe1 are data collected in step c).

15. The method according to claim 12, further comprising at least the step of characterizing the calorie intake reducing effect for pets of said candidate petfood selected in step j) by:
k) calculating Δcritₘₑₐₙ as a mean of all Δcrits, wherein Δcrit=crit(candidate petfood)−crit(control petfood) per pet, for at least one of the additional criteria measured in step d), wherein said at least one criterion is selected from CFE1, CFEₓ, and CTP_{y}.

16. The method according to claim 12, wherein CFE1 is calculated per pet as follows:
CFE1=(Wfe0−Wfe1)×ME,
with Wfe0=W0: weight of the petfood at the start of the feeding trial,
Wfe1: weight of the petfood after the first feeding event, and
ME: metabolizable energy (expressed in Kcal/weight unit);
and wherein W0 and Wfe1 are data collected in step c).

17. The method according to claim 15, wherein CFE1 is calculated per pet as follows:
CFE1=(Wfe0−Wfe1)×ME,
with Wfe0=W0: weight of the petfood at the start of the feeding trial,
Wfe1: weight of the petfood after the first feeding event, and
ME: metabolizable energy (expressed in Kcal/weight unit);
and wherein W0 and Wfe1 are data collected in step c).

18. The method according to claim 12, wherein CFEₓ is calculated per pet as follows:
CFEₓ=(Wfeₓ₋₁−Wfeₓ)×ME,
with Wfeₓ: weight of the petfood after the feeding event x,
Wfeₓ₋₁: weight of the petfood after the feeding event x-1,
ME: metabolizable energy (expressed in Kcal/weight unit),
x representing a feeding event, x-1 representing the feeding event immediately before the feeding event x, x being from 1 to N, and N being the total number of feeding events during the feeding trial,
and wherein Wfeₓ, Wfeₓ₋₁, and N are data collected in step c).

19. The method according to claim 15, wherein CFEₓ is calculated per pet as follows:
CFEₓ=(Wfeₓ₋₁−Wfeₓ)×ME,
with Wfeₓ: weight of the petfood after the feeding event x,
Wfeₓ₋₁: weight of the petfood after the feeding event x-1,
ME: metabolizable energy (expressed in Kcal/weight unit),
x representing a feeding event, x-1 representing the feeding event immediately before the feeding event x, x being from 1 to N, and N being the total number of feeding events during the feeding trial,
and wherein Wfeₓ, Wfeₓ₋₁, and N are data collected in step c).

20. The method according to claim 12, wherein CTP_{y} is calculated per pet as follows:
CTP_{y}=(W0−Wtp_{y})×ME,
with W0: weight of the petfood at the start of the feeding trial,
Wtp_{y}: weight of the petfood at the end of the time period y,
ME: metabolizable energy (expressed in Kcal/weight unit),
y representing a time period, y being from 1 to P, and P being the total number of time periods regularly dividing the total duration of the feeding trial (tD),
wherein tD=Tfin−T0,
with T0: starting time of the feeding trial, and
Tfin: ending time of the feeding trial,
and wherein Wtp_{y}, T0, and Tfin are data collected in step c).

21. The method according to claim 15, wherein CTP_{y} is calculated per pet as follows:
CTP_{y}=(W0−Wtp_{y})×ME,
with W0: weight of the petfood at the start of the feeding trial,
Wtp_{y}: weight of the petfood at the end of the time period y,
ME: metabolizable energy (expressed in Kcal/weight unit),
y representing a time period, y being from 1 to P, and P being the total number of time periods regularly dividing the total duration of the feeding trial (tD),
wherein tD=Tfin−T0,
with T0: starting time of the feeding trial, and
Tfin: ending time of the feeding trial,
and wherein Wtp_{y}, T0, and Tfin are data collected in step c).

22. A method for selecting a petfood having both a palatability effect and a hypocaloric effect for pets, comprising at least:
performing the method according to claim 16; and
if ΔtCₘₑₐₙ<0 and ΔDFE1ₘₑₐₙ≤0 and ΔNbFElowₘₑₐₙ≤0 and ΔCFE1ₘₑₐₙ<0, then selecting the candidate petfood as said candidate petfood has a hypocaloric effect for pets and as it is at least as palatable as the control petfood.

23. A method for selecting a petfood having both a palatability effect and a hypocaloric effect for pets, comprising at least:
performing the method according to claim 17; and
if ΔtCₘₑₐₙ<0 and ΔDFE1ₘₑₐₙ≤0 and ΔNbFElowₘₑₐₙ≤0 and ΔCFE1mean<0, then selecting the candidate petfood as said candidate petfood has a hypocaloric effect for pets and as it is at least as palatable as the control petfood.

24. A method for selecting a petfood having both a palatability effect and a satiating but not hypocaloric effect for pets, comprising at least:
performing the method according to claim 16; and
if ΔtCₘₑₐₙ<0 and ΔDFE1ₘₑₐₙ≤0 and ΔNbFElowₘₑₐₙ≤0 and ΔCFE1ₘₑₐₙ≥0, then selecting the candidate petfood as said candidate petfood has a satiating but not hypocaloric effect for pets and as it is at least as palatable as the control petfood.

25. A method for selecting a petfood having both a palatability effect and a satiating but not hypocaloric effect for pets, comprising at least:
performing the method according to claim 17; and
if ΔtCₘₑₐₙ<0 and ΔDFE1ₘₑₐₙ≤0 and ΔNbFElowₘₑₐₙ≤0 and ΔCFE1ₘₑₐₙ≥0, then selecting the candidate petfood as said candidate petfood has a satiating but not hypocaloric effect for pets and as it is at least as palatable as the control petfood.

26. A method for feeding a pet, comprising at least:
performing the method according to claim 12, thereby selecting a candidate petfood; and
feeding said pet with said petfood.

27. A method for feeding a pet, comprising at least:
performing the method according to claim 22, thereby selecting a candidate petfood; and
feeding said pet with said petfood.

28. A method for feeding a pet, comprising at least:
performing the method according to claim 23, thereby selecting a candidate petfood; and
feeding said pet with said petfood.

29. A method for feeding a pet, comprising at least:
performing the method according to claim 24, thereby selecting a candidate petfood; and
feeding said pet with said petfood.

30. A method for feeding a pet, comprising at least:
performing the method according to claim 25, thereby selecting a candidate petfood; and
feeding said pet with said petfood.
